(19) United States
(12) Patent Application Publication
(10) Pub. No.: US 2004/0257990 A1
(43) Pub. Date: Dec. 23, 2004

(54) Interchassis switch controlled ingress transmission capacity

(75) Inventors: Charles Steven Lingafelt, Durham, NC (US); Norman Clark Strole, Raleigh, NC (US)

Correspondence Address: SAWYER LAW GROUP LLP, PO BOX 51418, PALO ALTO, CA, 94303, US

(73) Assignee: International Business Machines Corporation, Armonk, NY

(21) Appl. No.: 10/465,108

(22) Filed: Jun. 19, 2003

(51) Int. Cl. H04L 12/26

(52) U.S. Cl. 370/230

(57) ABSTRACT

Disclosed is an apparatus including an interchassis network having a plurality of network interface connections; and an interchassis switch coupled to an egress communications system having an egress transmission capacity, a plurality of ingress transmission channels coupled to the plurality of network interface connections collectively having a potential ingress transmission capacity greater than the egress transmission capacity, and a capacity controller coupled to the plurality of ingress transmission channels for controlling an operational ingress capacity of the plurality of network interface connections. The method of controlling an ingress transmission capacity of an interchassis switch includes the steps of comparing the ingress transmission capacity to a threshold capacity; and controlling the ingress transmission capacity responsive to the ingress transmission capacity comparing step.

### CROSS-RELATED APPLICATION

The present application is related to application Serial No. ______ (RPS920030068US1) entitled “Management Module Controlled Ingress Transmission Capacity.”

### FIELD OF THE INVENTION

The present invention relates generally to controlling ingress transmission capacity of a switch, and more specifically to controlling a maximum ingress transmission capacity of an interchassis switch used in a blades and chassis server.

### BACKGROUND OF THE INVENTION

A blade and chassis configuration for a computing system includes one or more processing blades within a chassis. Also within the chassis are one or more integrated network switches that couple the blades together into an interchassis network as well as providing interface connections (NICs) for communicating with the switches.

In many implementations, an ingress transmission capacity into any individual switch exceeds the switch egress transmission capacity. The transmission capacity is a function of link speed and link load factor of the aggregated, active NICs. While the interchassis switch often includes an internal buffer that helps to moderate the effects of capacity mismatches, this internal buffer contributes to the final cost and complexity of the blades and chassis server.

Even with an internal buffer, the interchassis switch is always subject to buffer overruns because the NICs are able to transmit packets into receive buffers of the interchassis switch at a higher rate than the interchassis switch can transmit them out of outbound chassis buffers. The size of the buffer only affects how long a capacity mismatch can be sustained, but it does not eliminate buffer overrun conditions.

The buffer overrun condition results in dropped packets at the interchassis switch. The solution for a dropped packet is to cause such packets to be retransmitted by the original blade. Detecting these dropped packets and getting them retransmitted increases network latency and diminishes overall effective capacity. This problem is not unique to the Ethernet protocol and can also exist with other communications protocols.

Accordingly, what is needed is a system and method for decreasing the probability of buffer overruns and improving overall effective capacity of an interchassis network. The present invention addresses such a need.

### SUMMARY OF THE INVENTION

Disclosed is an apparatus including an interchassis network having a plurality of network interface connections; and an interchassis switch coupled to an egress communications system having an egress transmission capacity, a plurality of ingress transmission channels coupled to the plurality of network interface connections collectively having a potential ingress transmission capacity greater than the egress transmission capacity, and a capacity controller coupled to the plurality of ingress transmission channels for controlling an operational ingress capacity of the plurality of network interface connections. The method of controlling an ingress transmission capacity of an interchassis switch includes the steps of comparing the ingress transmission capacity to a threshold capacity; and controlling the ingress transmission capacity responsive to the ingress transmission capacity comparing step.

By controlling the maximum ingress transmission capacity, packets are not dropped which thereby significantly decreases network latency and improves network capacity.

### BRIEF DESCRIPTION OF THE DRAWINGS

FIG. 1 is a schematic block diagram of a blade and chassis computing system; and

FIG. 2 is schematic block diagram of an ingress transmission capacity control process.

### DETAILED DESCRIPTION

The present invention relates to controlling a maximum ingress transmission capacity of an interchassis switch used in a blades and chassis server. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

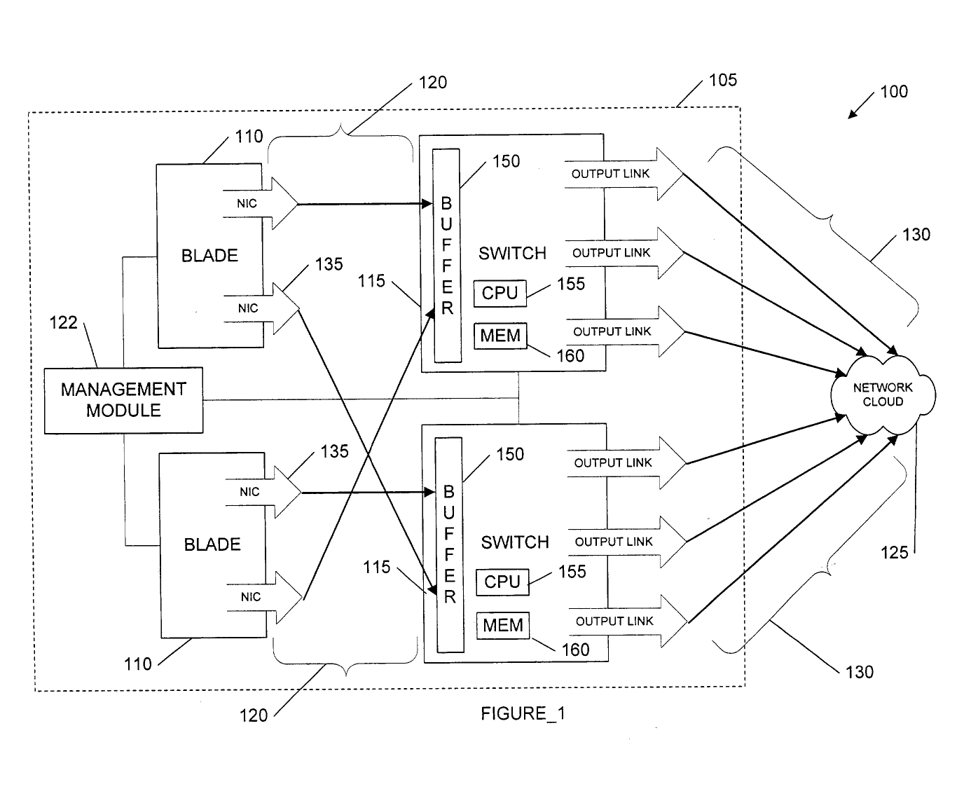

FIG. 1 is a schematic block diagram of a blade and chassis computing system 100. System 100 includes a chassis 105, one or more blades 110, and one or more interchassis switches 115 coupled to blades 110 by an interchassis network 120. Switches 115 are also coupled to an extrachassis communications system 125 by an extrachassis network 130. Each blade 110 has one or more network interface connections (NICs) 135 that couple it to one or more switches 115. In the preferred embodiment, each chassis 105 includes up to fourteen blades 110 and up to four switches 115, with one NIC 135 per blade 110 per switch 115 (i.e., there is one NIC 135 for every switch 115 on each blade 110). Each switch 115 defines one interchassis network 120, so there are as many interchassis networks 120 and extrachassis networks 130 as there are switches 115. In other implementations of the present invention, a different number of blades 105, switches 115 and/or NICs 135 may be used depending upon the particular needs or performance requirements.

Each switch 115 includes a buffer 150, a central processing unit (CPU) 155 (or equivalent) and a non-volatile memory 160. Buffer 150 holds incoming packets and outgoing packets, with switch 115 and buffer 150 controlled by CPU 155 as it executes process instructions stored in memory 160. Each interchassis network 120 has, using the switch as the reference frame, a maximum ingress transmission capacity and a maximum egress transmission capacity. The ingress transmission capacity is the aggregate capacity of all active links on network 120 into a particular switch 115 and the egress transmission capacity is the aggregate capacity of all active links on network 130 out of a particular switch 115.

Capacity of a network is a function of the link speed of the network elements and the load factor of those elements. It is known that link connections may have one or more discrete connection speeds (e.g., 10 Mb/sec, 100 Mb/sec and/or 1 Gb/sec), and it is known that the link speed may be auto-negotiated upon first establishing active devices at each end of the link (IEEE 802.3 includes a standard auto-negotiation protocol suitable for the present invention, though other schemes may also be used). The autonegotiation may be predetermined by statically determining the speed parameters of at least one of the devices. Typically, each detected link device is always connected and auto-negotiated at the greatest speed mutually supported. It is anticipated that a NIC 135 will be developed having a variable connection speed over some specified range. The present invention is easily adapted for use with such NICs 135 when they become available.

The present invention controls, per switch 115, the maximum ingress transmission capacity of each interchassis network 120 in response to the current ingress transmission capacity and the egress transmission capacity. The preferred embodiment is implemented in each interchassis switch 115 and dynamically controls maximum ingress transmission capacity by reducing/increasing link speeds and/or reducing/increasing the number of link connections. The link speeds are set either on a per NIC 135 basis, uniformly for all active NICs 135, or selectively, based upon different classifications of NICs 135. The maximum ingress transmission capacity may be changed periodically or it may change automatically in response to changes in the egress transmission capacity or the current ingress transmission capacity as compared to the current effective egress transmission capacity.

In operation, there are several factors that are used to calculate a preferred setting for NIC operation capacity (NICset):

BCap—aggregate capacity of all active blade links to the interchassis switch (N×NICset) (i.e., the ingress transmission capacity)

NCap—aggregate capacity of all active extrachassis network links to the interchassis switch (i.e., the egress transmission capacity)

NICset—capacity of a single NIC (BCap/N)

N—number of NICs attached to the interchassis switch

LoadFactor—the average load or utilization factor, between 0 and 1, of the blade links

NCap is, in the preferred embodiment, assumed to be a fixed value determined by a number of external network links and their available peak capacity, while BCap and LoadFactor are taken as adjustable parameters. LoadFactor varies depending upon several well-known factors, including type(s) of application(s) and time of time-of-day. For example, an aggregate NCap of 2 gigabits/second could support up to 10 internal 1 gigabit/second links (BCap=10 gigabits/second) if the LoadFactor is 0.2 or less. However, if 14 internal links were active, the overall BCap would be reduced to achieve the desirable operational range.

The preferred embodiment adjusts BCap by controlling N and/or NICset. Interchassis switch 115 may set individual NIC rates to the same value (NICset) so that the aggregate N×NICset is less than or equal to the desired BCap/LoadFactor value. Switch 115 may reduce the maximum number (N) of active blades 105 allowed such that Nmax×NICset is less than or equal to the required BCap/LoadFactor value. Switch 115 may allocate NIC bandwidth using classes of NICs or other prioritization systems. For example, a first set M of NICs may have a first value for NICset1 with remaining NICs having NICset2 so that (M×NICset1)+((Nmax−M)×NICset2) is less than BCap/LoadFactor, based upon apriori knowledge of blade application requirements or similar blade-dependent factors.

Switch 115 sets and enforces NICset based upon each NIC and/or switch 115 dependent upon the NIC and/or switch design and capability. For example, most Ethernet NICs support both 100 Mbps and 1 Gbps rates at the physical link level. Using these two discrete link speeds, a NIC can be selectively set to either 100 Mbps or 1 Gbps via the IEEE 802.3 standard auto-negotiation. Currently, this standard does not permit a link speed to be changed after it is initially set, therefore the preferred embodiment will disconnect and auto-negotiate a new appropriate rate for an active link that is to be changed.

However, rates other than 10, 100, 1000 Mbps (e.g., 500 Mbps) could be enforced via firmware within NICs and/or NIC driver software on the blades and switch, with the 802.3 standard used to auto-negotiate the NIC link speed NICset.

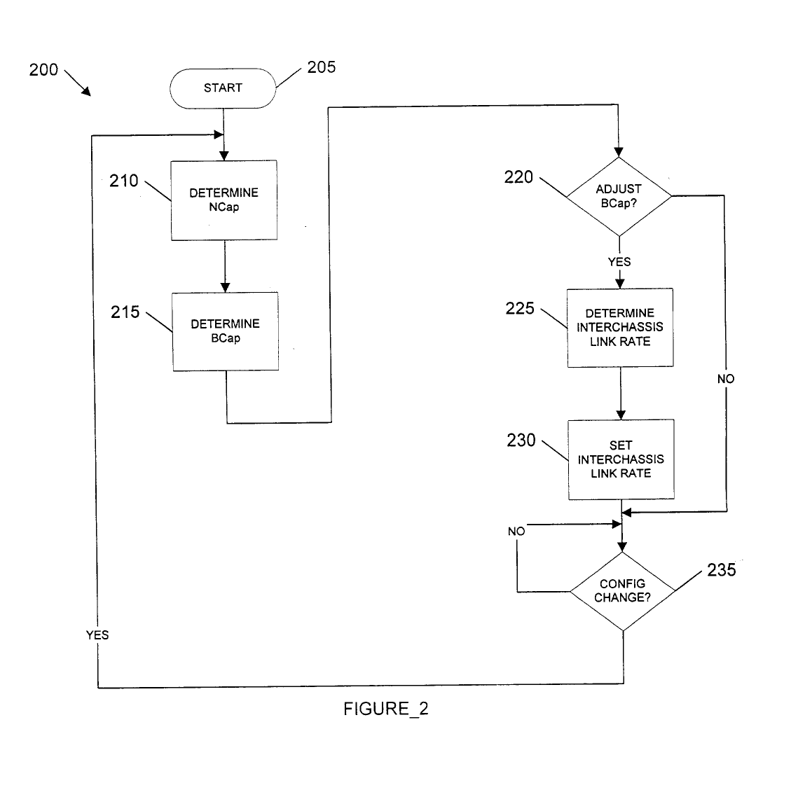

FIG. 2 is a schematic block diagram of a preferred embodiment for an ingress transmission capacity control process 200 implemented by interchassis switch 115. Process 200 is initialized at step 205 and then, at step 210, determines the egress transmission capacity (NCap) of extrachassis network 130.

Next at step 215, process 200 tests whether a new NIC has become active in the interchassis network 120. If no new NIC is active, process 200 cycles back to step 215, continuing to test until a new NIC is active.

When the test at step 215 is positive, process 200 advances to step 220. Step 220 auto-negotiates NICset for the new NIC such that N×NICset is less than or equal to NCap/LoadFactor.

After setting NICset at step 220, process 200 performs another test at step 225. Step 225 tests whether there has been any change to the chassis configuration. If no changes are detected, process 200 continues to loop at step 225 until a chassis change is detected. When step 225 detects a chassis configuration change, process 200 returns to step 205.

Depending upon specific implementations and application requirements, process 200 may be adapted and modified without departing from the present invention. For example, process 200 may disable one or more selected NICs and inhibit reconnection as discussed above. In some implementations, certain blades may have a higher priority than other blades. In these cases, process 200 can selectively restrict NICset or disconnect NICs of lesser priority blades. Also, the BCap may be tuned using dynamic information relating to the LoadFactor of the ingress transmission capacity.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. An apparatus, comprising:
an interchassis network including a plurality of network interface connections; and
an interchassis switch coupled to an egress communications system, the interchassis switch having an egress transmission capacity, the interchassis switch including a plurality of ingress transmission connections collectively having an ingress transmission capacity greater than the egress transmission capacity, and a capacity controller coupled to the plurality of ingress transmission channels for controlling a maximum ingress capacity of the plurality of network interface connections.

2. The apparatus of claim 1 wherein each of the network interface connections is operable at a plurality of link speeds and wherein the capacity controller controls ingress transmission capacity by selecting an up-to-maximum link speed for one or more of the network interface connections.

3. The apparatus of claim 1 wherein the capacity controller controls ingress transmission capacity to not exceed the egress transmission capacity.

4. The apparatus of claim 1 wherein the egress transmission capacity changes periodically and wherein the capacity controller dynamically controls the ingress transmission capacity responsive to current egress transmission capacity and current ingress transmission capacity.

5. The apparatus of claim 1 wherein the ingress transmission capacity changes periodically and wherein the capacity controller dynamically controls the ingress transmission capacity responsive to current egress transmission capacity and current ingress transmission capacity.

6. The apparatus of claim 1 wherein the interchassis switch includes a buffer and wherein the capacity controller dynamically controls the ingress transmission capacity responsive to current egress transmission capacity, current ingress transmission capacity and current buffer capacity.

7. The apparatus of claim 2 wherein a particular link speed of a connection between a network interface component and the interchassis switch results from a predetermined auto-negotiation.

8. The apparatus of claim 7 wherein the capacity controller drops a link and controls the predetermined auto-negotiation to select a suitable one of the plurality of link speeds when it controls ingress transmission capacity.

9. The apparatus of claim 1 wherein the capacity controller includes a port speed priority for each of the plurality of network interface connections and wherein the capacity controller uses the port speed priority when controlling the ingress transmission capacity.

10. The apparatus of claim 2 wherein the capacity controller controls the ingress transmission capacity using multiple link speeds for the plurality of network interface connections.

11. The apparatus of claim 2 wherein the capacity controller controls the ingress transmission capacity using a matching link speed for the plurality of network interface connections.

12. The apparatus of claim 1 wherein the capacity controller controls the ingress transmission capacity by inhibiting establishment of new links between one or more network interface connections and the interchassis switch.

13. A method of controlling an ingress transmission capacity of an interchassis switch, comprising the steps of:
a) comparing the ingress transmission capacity to a threshold capacity; and
b) controlling the ingress transmission capacity responsive to the ingress transmission capacity comparing step a).

14. The method of claim 13 wherein each of the network interface connections is operable at a plurality of link speeds and wherein the controlling step b) controls ingress transmission capacity by selecting an up-to-maximum link speed for one or more of the network interface connections.

15. The method of claim 13 wherein the interchassis switch includes an egress transmission capacity and wherein the controlling step b) controls ingress transmission capacity to not exceed the egress transmission capacity.

16. The method of claim 13 wherein the interchassis switch includes an egress transmission capacity that changes periodically and wherein the controlling step b) dynamically controls the ingress transmission capacity responsive to current egress transmission capacity and current ingress transmission capacity.

17. The method of claim 13 wherein the interchassis switch includes an egress transmission capacity, wherein the ingress transmission capacity changes periodically and wherein the controlling step b) dynamically controls the ingress transmission capacity responsive to current egress transmission capacity and current ingress transmission capacity.

18. The method of claim 13 wherein the interchassis switch includes a buffer and an egress transmission capacity and wherein the controlling step b) dynamically controls the ingress transmission capacity responsive to current egress transmission capacity, current ingress transmission capacity and current buffer capacity.

19. The method of claim 14 wherein a particular link speed of a connection between a network interface component and the interchassis switch results from an auto-negotiation.

20. The method of claim 19 wherein the controlling step b) terminates a link and controls a subsequent auto-negotiation of the link to select a suitable one of the plurality of link speeds when it controls ingress transmission capacity.

21. The method of claim 13 wherein the controlling step b) uses a port speed priority for each of the plurality of network interface connections when controlling the ingress transmission capacity.

22. The method of claim 14 wherein the controlling step b) controls the ingress transmission capacity using multiple link speeds for the plurality of network interface connections.

23. The method of claim 14 wherein the controlling step b) controls the ingress transmission capacity using a matching link speed for the plurality of network interface connections.

24. The method of claim 13 wherein the controlling step b) controls the ingress transmission capacity by inhibiting establishment of new links between one or more network interface connections and the interchassis switch.

25. An apparatus for controlling an ingress transmission capacity of an interchassis switch, comprising:
means for comparing the ingress transmission capacity to a threshold capacity; and
means for controlling the ingress transmission capacity responsive to the ingress transmission capacity comparison.
